(19) United States
(12) Patent Application Publication
(10) Pub. No.: US 2006/0087841 A1
(43) Pub. Date: Apr. 27, 2006

(54) LED luminaire with feedback control

(75) Inventors: Jyh-Long Chern, Hsinchu (TW); Shiao-Wen Lu, Hsinchu (TW)

Correspondence Address: RATNERPRESTIA, P O BOX 980, VALLEY FORGE, PA, 19482-0980, US

(73) Assignee: United Epitaxy Company, Ltd.

(21) Appl. No.: 10/974,341

(22) Filed: Oct. 27, 2004

(51) Int. Cl. F21V 9/00

(52) U.S. Cl. 362/231

(57) ABSTRACT

An LED luminaire includes an array of LEDs, a multiple-to-one contractor, a pickup optical element, and a light sensor. The array of LEDs has at least one LED in each of a plurality of colors so as to generate a combined light output. The multiple-to-one contractor is positioned to direct the combined light output to a target light guide. A pickup optical element is positioned to extract a portion of the light output from the multiple-to-one contractor. The light sensor is positioned to measure at least a portion of the extracted light so as to adjust the light output of the LEDs.

### FIELD OF INVENTION

The present invention generally relates to a luminaire with an array of light emitting diodes in a plurality of colors, and more particularly, to an LED luminaire with feedback control for adjusting individual LEDs to achieve a desired color balance.

### BACKGROUND OF THE INVENTION

White light emitting luminaries having arrays of red, green, and blue LEDs, which are also known as RGB luminaries, are of interest for several reasons, including efficiency, low cost, and an ability to adjust the chromaticity of the light output by which colorful light emission can be achieved for novel color lighting such as decoration. Furthermore, compact-size luminaries are suitable for pocketed-size projector applications, which feature potential needs in the markets of home-electronics and consumer opto-electronics.

One of the important problems to be addressed is the variation in light output of the LEDs from chip to chip, as well as over the life of each chip. Light output of the LEDs also varies inversely with temperature, but not uniformly for each color. In application of pocketed-size projectors, the loss of optical throughput and the associated heat problem can be serious, and the failure of temperature maintenance degrades the performance of output power and color balance. In addition, light output varies with the failure of individual chips within an LED array. Another problem is with the efficiency of light collection. Light combination that can be achieved with common lens element, commonly refractive optics, e.g. condenser, dichroism mirrors, is inevitably with some loss. In contrast, reflector has higher efficiency, while contractor, such as compound parabolic contractor (CPC) or Winston cone, can achieve the highest efficiency. Examples can be identified in literature. For application in RGB LED luminaries with feedback control, it is necessary to improve, i.e. reshape and/or reconfigurate common CPC such as multiple color light sources and even multiple exit ports for sensor feedback configuration.

U.S. Pat. No. 6,127,783, issued to Michael D. Pashley et al. and assigned to Philips Electronics North America Corp., discloses a white light emitting luminaire with electronically adjusted color balance. The patented luminaire includes a plurality of LEDs in each of the colors red, green, and blue with a separate power supply for each color and a photodiode arranged to measure the light output of all the LEDs. The light output of each color is measured by an electronic control circuit, which turns off the LEDs for the colors not being measured in a sequence of time pulses. The measured light output for each color is compared to a desired output, which may be determined by user inputs, and corrections to the current for each color are made accordingly. In order to accurately control the output of such a luminaire, the total delivered light must be monitored accurately. This requires placing the photodiodes in such a manner that an equal fraction of light is sampled from each LED while allowing sufficient stray light from the LEDs to fall on the photodiodes to ensure satisfactory operation of the feedback loop. U.S. Pat. No. 6,741,351, issued to Michael D. Pashley et al. and assigned to Koninllijke Philips Electronics N. V., discloses an LED luminaire with light sensor configurations for optical feedback. The optical feedback is mainly achieved by partially reflected light, which may degrade the performance, due to unwanted optical feedback. On the other hand, the incorporation of condenser lens degrades the efficiency of light collection and causes a larger loss of optical throughput.

In the annual meeting of the Society of Information Display of 2004 (SID 2004), M. H. Keuper et al. of Lumileds lightings, demonstrated an RGB illuminator for pocket-sized projectors. Volume of a light engine, including optics, heat sinks, and light-feedback electronics, was around 100 cc. The optics includes one light tunnel, one condenser lens, dichroism, and mirrors. Furthermore, the LEDs have been collimated. The loss of optical throughput is serious and heat sink demanded to maintain the LED performance.

Therefore, there is an emergent need to provide an LED luminaire with feedback control capable of achieving color balance and inducing minimum loss of light output.

### SUMMARY OF THE INVENTION

In viewing the drawbacks of prior arts, one aspect of the present invention relates to a white light emitting luminaire, which has an array of red, green, and blue light emitting diodes and a control system for adjusting the light output of individual components to maintain a desired color balance (chromaticity).

Another aspect of the present invention is to provide an LED luminaire having specific light extraction configurations for optical feedback and specific configurations of light combination.

A further aspect of the present invention is to provide a color light emitting luminaire in which intensities of three basic color LEDs of red, green, and blue could be adjusted as needed.

The present invention provides an LED luminaire, which considers the high efficiency of light collection of a compound parabolic contractor (CPC) as an exemplary configuration of light combination. At least a portion of the light output from the contractor is extracted and measured to establish the feedback control so as to achieve the color balance of the LED luminaire.

In one embodiment of the present invention, an LED luminaire includes an array of LEDs, a multiple-to-one contractor, a pickup optical element, and a light sensor. The array of LEDs includes at least one LED in each of a plurality of colors to generate a combined light output. The multiple-to-one contractor is positioned to direct the combined light output of the array of LEDs to a target light guide. The pickup optical element is positioned to extract a portion of the light output from the multiple-to-one contractor. The light sensor is positioned to measure at least a portion of the extracted light so as to adjust the light output of the LEDs.

In an exemplary embodiment, the pickup optical element is selected from a group consisting of a light guide, a color filter, a prism, a grating, a grism, and a combination thereof. The LED luminaire further includes means for supplying electrical current to the array of LEDs, so that the LEDs in each color have a light output, and the array of LEDs has the combined light output; means for providing the extracted light output of each color separately to the light sensor; means for comparing the measured light output for each color to a respective desired light output for each color; and means for adjusting the electrical current to the LEDs in each color based on the comparison to achieve a desired combined light output. In an exemplary embodiment, the means for providing the extracted light output of each color separately to the light sensor includes means for selectively turning off the LEDs so that the light sensor measures the light output for each color separately in a series of time pulses. Alternatively, the means for providing the extracted light output of each color separately to the light sensor includes color filter means for selectively filtering out the light output of each separate LED color.

In another embodiment of the present invention, an LED luminaire includes an array of LEDs, a multiple-to-multiple contractor, and at least one light sensor. The array of LEDs includes at least one LED in each of a plurality of colors to generate a combined light output. The multiple-to-multiple contractor is positioned to direct the combined light output of the array of LEDs to a target light guide. At least one light sensor is positioned at one or several exit ports of the contractor to extract a portion of the light output back to the LED array to form the feedback control loop.

Another further aspect of the present invention is to provide an LED luminaire, which utilizes a compound parabolic contractor to enhance the light collection efficiency and reduce the loss of light throughput, and has light sensors correspond to the LEDs to measure light output for each color.

Another aspect of the present invention is to provide an LED luminaire, which includes separate optics and a combiner (or light tube) so as to guide light output of each color to an array of light sensors.

In another embodiment of the present invention, an LED luminaire includes an array of LEDs including at least one LED in each of a plurality of colors, separate optics positioned to correspond the array of LEDs so as to filter at least a portion of the light output of the LEDs in each color; a combiner for guiding at least a portion of the filtered light output; and an array of light sensors. Each light sensor is positioned to intercept and measure at least a portion of the light output guided by the combiner.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic view of an LED luminaire in accordance with a first embodiment of the present invention;

FIG. 2 illustrates a schematic view of arrangement of feedback control system in accordance with one embodiment of the present invention;

FIGS. 3A and 3B illustrate schematic views of light sensor in accordance with one embodiment of the present invention;

FIG. 4 illustrates a schematic view of an LED luminaire in accordance with a second embodiment of the present invention;

FIGS. 5A and 5B illustrate schematic view of an LED luminaire in accordance with a third embodiment of the present invention;

FIGS. 6A and 6B illustrate schematic views of and LED luminaire in accordance with a fourth embodiment of the present invention; and

FIGS. 7A-7C illustrate schematic views of LEDs with different separate optics in accordance with another embodiment of the present invention.

### DETAILED DESCRIPTION OF THE INVENTION

Based on a high-efficiency contractor design in sun energy collection (W. T. Welford and R. Winston, “High collection non-imaging optics”, Academic Press, New York, 1989), the present invention provides several optical configurations for collecting light emission from LED and/or LED arrays. Positioning one or more photodiodes, optionally with various color filters and optical element, in and around the light path of a RGB LED luminaire to achieve an equal fraction of light sampled from each LED, the total light output can be monitored accurately. Only minor modifications to a standard RGB LED luminaire's optical system are needed, and efficiency and other performance specifications are substantially unaffected. With the photodiodes so positioned, feedback signals are available to the control electronics to regulate both total light output and color balance. The size can be rather compact by reshaping the contractor.

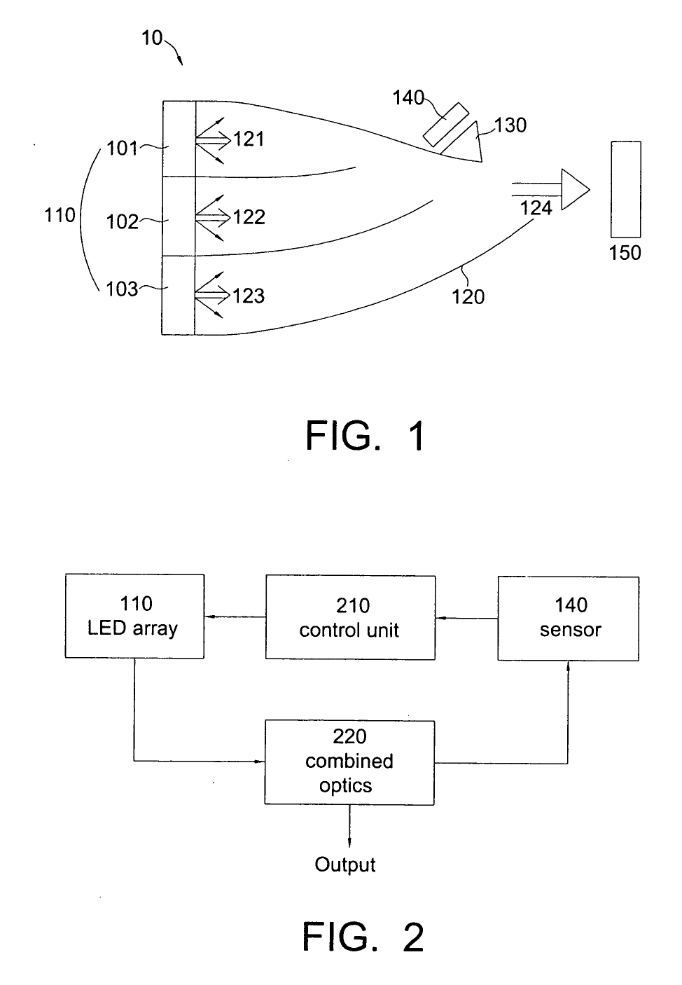

Referring to FIG. 1, in a first embodiment of the present invention, an LED luminaire 10 includes an array of LEDs 110, a multiple-to-one contractor 120, a pickup optical element 130, and a light sensor 140. The array of LEDs 110 includes at least one LED in each of a plurality of colors, such as primary colors of red, green, and blue (101, 102, 103), to generate a combined light output, such as white light output. The multiple-to-one contractor 120 is positioned to direct the combined light output of the array of LEDs 110 to a target light guide 150. The pickup optical element 130 is positioned to extract a portion of the light output from the multiple-to-one contractor 120. The light sensor 140 is positioned to measure at least a portion of the extracted light so as to adjust the light output of the LEDs (101, 102, 103).

For example, a typically three-to-one contractor 120 (Julio Chaves and Manuel Collares-Pereira, “Ideal concentrators with gaps,” Appl. Opt. 41, 1267 (2002)) is utilized. The light from each LED package (101, 102, 103), which includes an LED chip or LED arrays, is directed to the entrance ports (121, 122, 123) of the three-in-one contractor 120. Simulations and analysis have shown that high uniform irradiance can be achieved from the exit port 124 of the contractor 120. The light collection efficiency, i.e., the optical throughput from the exit port 124 of the contractor 120, is very high because of the nature of compound parabolic contractor (CPC, or Winston cone). The collection efficiency can be further improved if low-loss cover materials are used, instead of the common aluminum (Al) coating. The three-to-one contractor 120 could be modified into multiple-to-one contractor when more LED packages are needed to increase the output power.

The pickup optical element 130 is selected from a group consisting of a light guide, a color filter, a prism, a grating, a grism, and a combination thereof. The pickup optical element 130 is positioned at the exit port 124 of the contractor 120 and followed by the light sensor 140 to monitor output light emission at a selective bandwidth. That is, a portion of the light output from the three-to-one contractor 120 is extracted by the pickup optical element 130, and then measured by the light sensor 140.

The LED luminaire 10 further includes means for supplying electrical current to the array of LEDs so that the LEDs in each color have a light output, and the array of LEDs has the combined light output. The LED luminaire 10 further includes means for providing the extracted light output of each color separately to the light sensor, means for comparing the measured light output for each color to a respective desired light output for each color, and means for adjusting the electrical current to the LEDs in each color based on the comparison to achieve a desired combined light output. For example, referring to FIG. 2, the control unit 210 provides the electrical current to the arrays of LEDs 110 so that the LEDs in each color (101, 102, 103) have a light output, and the array of LEDs 110 has the combined light output, which is directed to the entrance ports (121, 122, 123) of the contractor 120. It is noted that the combined optics 220 may represent the contractor 120 and/or any optics, such as the pickup optical element 130, implemented in this embodiment as appropriate. A portion of the light output from the contractor 120 is extracted by the pickup optical element 130, which can be a light guide, so that a wavelength selective optical element 310, such as prism, diffractive optics, grating, grism, or color filter, is provided to guide the light output of each color separately to the light sensor 140. The light sensor 140 then measures the extracted light output, and the control unit 210 compares the measured light output for each color to a respective desired light output for each color. The desired light outputs can be stored in the control unit 210, or inputted by the user. Then, based on the comparison result, the control unit 210 adjusts the electrical current to the LEDs in each color (101, 102, 103) to achieve a desired combined light output.

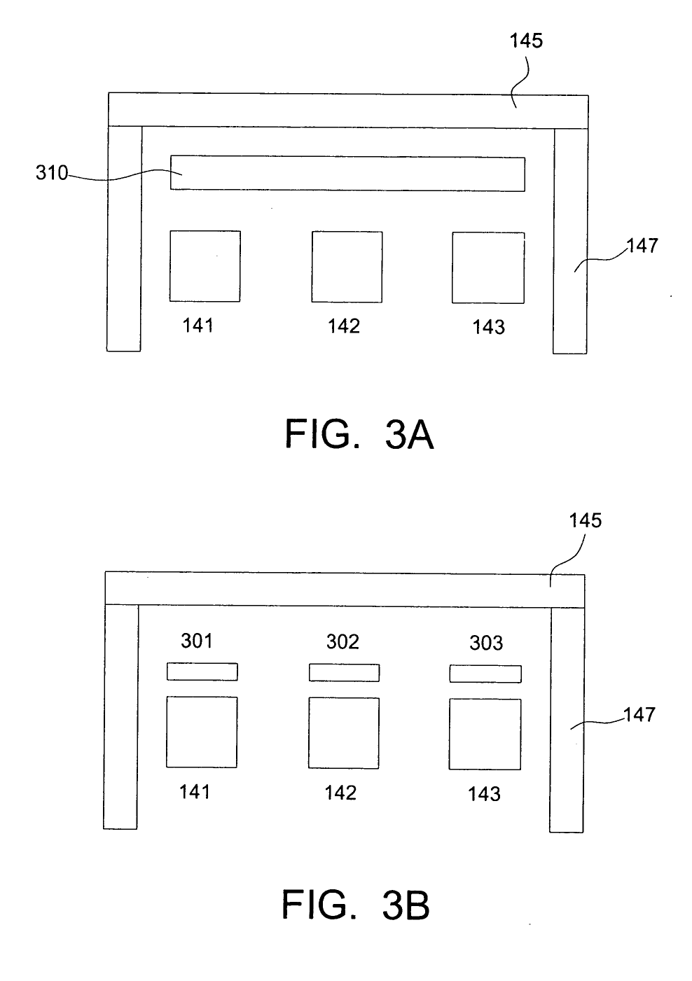

Alternatively, the means for providing the extracted light output of each color separately to the light sensor 140 can be means for selectively turning off the LEDs (101, 102, 103) so that the light sensor 140 measures the light output for each color separately in a series of time pulses. For example, the control unit 210 selectively turns off the LEDs (101, 102, 103), so that the use of color filters to isolate the light output of different color is not needed. In other words, the control unit 210 sequentially provides the electrical current to the LEDs in each color (101, 102, 103), so that the light sensor 140 measures the light output for each other separately in a series of time pulses. Furthermore, the light sensor 140 may include an array of photodiodes (141, 142, 143). The wavelength selective optical element 310 may include separate color filters (301, 302, 303) corresponding to each other and associated with the individual photodiodes (141, 142, 143). Moreover, the light sensor 140 further comprises a light diffuser 145 and a light integrator 147, as shown in FIGS. 3A and 3B.

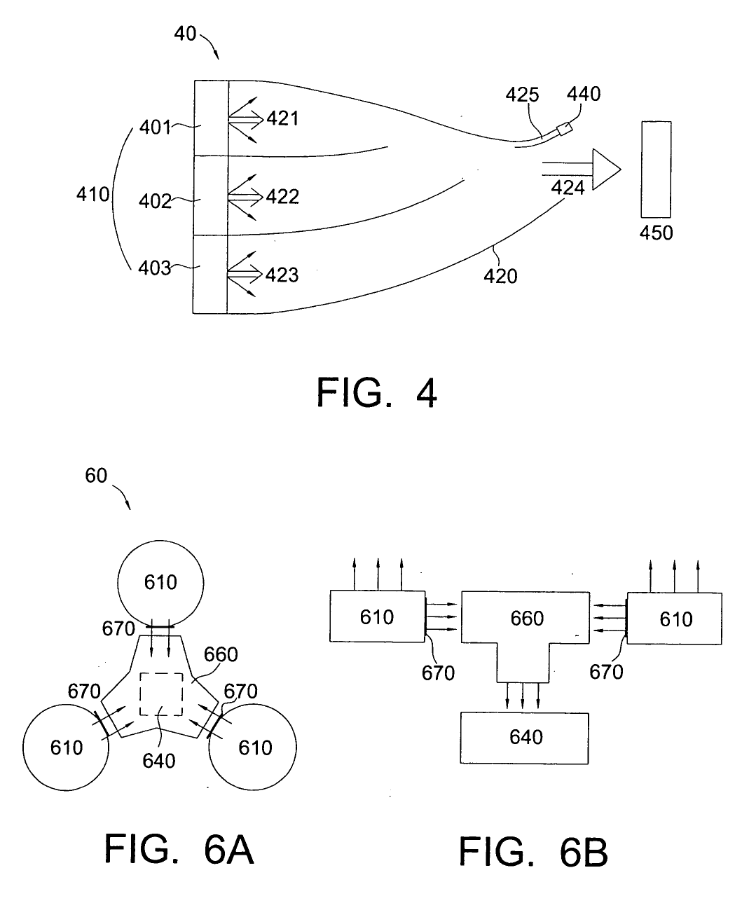

Referring to FIG. 4, in a second embodiment of the invention, an LED luminaire 40 includes an array of LEDs 410, a multiple-to-multiple contractor 420, and at least one light sensor 440. The array of LEDs 410 includes at least one LED in each of plurality of colors, such as R, G, and B LEDs (401, 402, 403), which can be arranged similarly to that of the first embodiment. The multiple-to-multiple contractor 420 which can be a three-to-two contractor is positioned to direct the combined light output of the array of LEDs 410 to a target light guide 450. At least one light sensor 440 is positioned at one or several exit ports 425 of the contractor 420 to extract a portion of the light output back to the LED array 410 to form the feedback control loop.

In other words, the typical three-to-one contractor 120 of the first embodiment is modified to be the three-to-two contractor 420. There are three entrance ports (421, 422, 423) designed for basic RGB LEDs individually. Two exit ports (424, 425) are designed so that only a small fractional output is directed to one exit port 425 where a wavelength selective optical element 310 (prism, diffractive optics, grating, or grism) is positioned. The wavelength selective optical element is followed by separate photodiode 440 to monitor output light emission at a selective bandwidth. The dominant portion of output is directed to the other exit port. The light from each LED package (401, 402, 403), which includes an LED chip or LED arrays, is directed to the entrance ports (421, 422, 423) of three-to-two contractor 420. The contractor 420 is designed to be a three-to-two contractor in which two exit ports (424, 425) are assigned and their emission ratio can be adjusted to meet the need of feedback control and output emission. Because the reflector is essentially a contractor, the emission can be rather uniform. In this embodiment, no additional light extraction element is required. Moreover, a multiple-to-multiple contractor is documented to increase the capacity of power and convenience of monitor optics. Alternatively, the three-to-two contractor 420 could be modified into a multiple-to-multiple contractor when more LED packages are needed to increase the output power and more monitor channels of output light performance are requested.

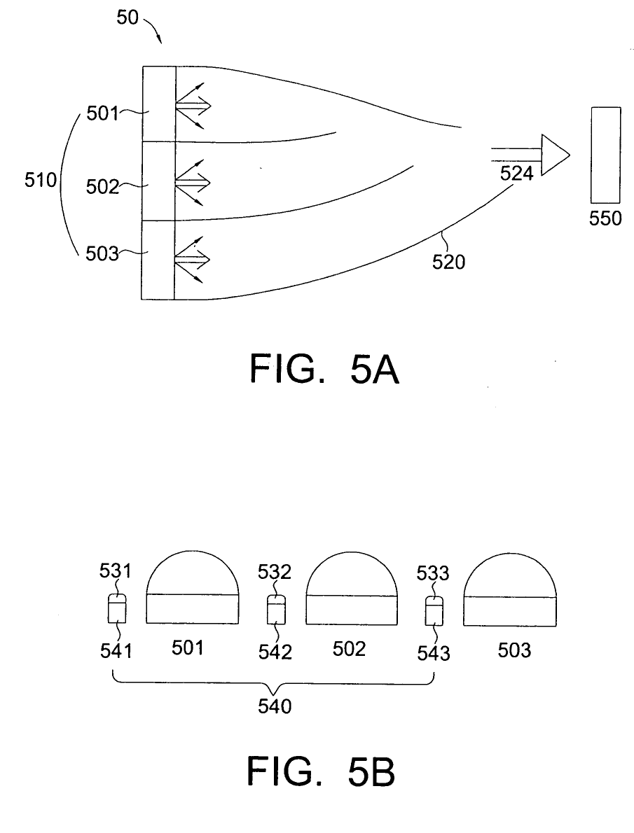

Referring to FIGS. 5A and 5B, in a third embodiment, an LED luminaire 50 includes an array of LEDs 510, which is similar to that of the first and the second embodiments, a compound parabolic contractor 520, and an array of light sensors 540. The compound parabolic contractor 520 is positioned to direct the combined light output of the array of LEDs 510 to a target light guide 550. Each light sensor (541, 542, 543) in the array is associated with an LED (501, 502, 503) or a partial array of LEDs and positioned to intercept and measure at least a portion of the light output of its associated LED or partial array of LEDs. At least first and second ones of the light sensors (541, 542) are adapted to intercept and measure light output from mutually-exclusive subsets of the LEDs. In this embodiment, the LED luminaire 50 utilizes a compound parabolic contractor 520 to enhance the light collection efficiency and reduce the loss of light throughput and also has light sensors (541, 542, 543) corresponding to the LEDs (501, 502, 503) to measure light output for each color.

In other words, the position of the light sensor (541, 542, 543) in the third embodiment is arranged with respect to the LEDs (501, 502, 503) or a subset of LEDs instead of being at the exit port 524 of the contractor 520. The LED luminaire 50 further includes a first filter 531 configured and arranged with the first light sensor 541 to pass light from a first one 501 of the mutually-exclusive subsets of the LEDs to the first light sensor 541 and to filter light from a second one 502 of the mutually-exclusive subsets of the LEDs. The LED luminaire 50 further includes a second filter 532 configured and arranged with the second light sensor 542 to pass light from the second one 502 of the mutually-exclusive subsets of the LEDs to the second sensor 542 and to filter light from the first one 501 of the mutually-exclusive subsets of the LEDs. The first light sensor 541 is configured and arranged with the array of LEDs so that light from a first one 501 of the mutually-exclusive subsets of LEDs reaches the first light sensor 541, and that light from a second one 502 of the mutually-exclusive subsets of LEDs does not reach the first light sensor 541. Moreover, the second light sensor 542 is configured and arranged with the array of LEDs so that light from the second one 502 of the mutually-exclusive subsets of LEDs reaches the second light sensor 542, and that light from the first one 501 of the mutually-exclusive subsets of LEDs does not reach the second light sensor 542.

Referring to FIGS. 6A and 6B, in a fourth embodiment, an LED luminaire 60 includes an array of LEDs 610 similar to that of the first embodiment, separate optics 670, a combiner 660 (or combined light tube), and an array of light sensors 640. The separate optics 670 is positioned to correspond to the array of LEDs 610 so as to filter at least a portion of the light output of the LEDs 610 in each color. The combiner 660 guides at least a potion of the filtered light output. Each light sensor 640 positioned to intercept and measure at least a portion of the light output guided by the combiner 660. FIG. 6A is a top view showing that a group of LEDs 610 is arranged around the combiner 660 so that the combiner 660 guides a portion of the light output of each LED 610 to the light sensor 640. FIG. 6B is a cross-sectional view showing that the position of the light sensor 640 with respect to the combiner 660 and the LEDs 610.

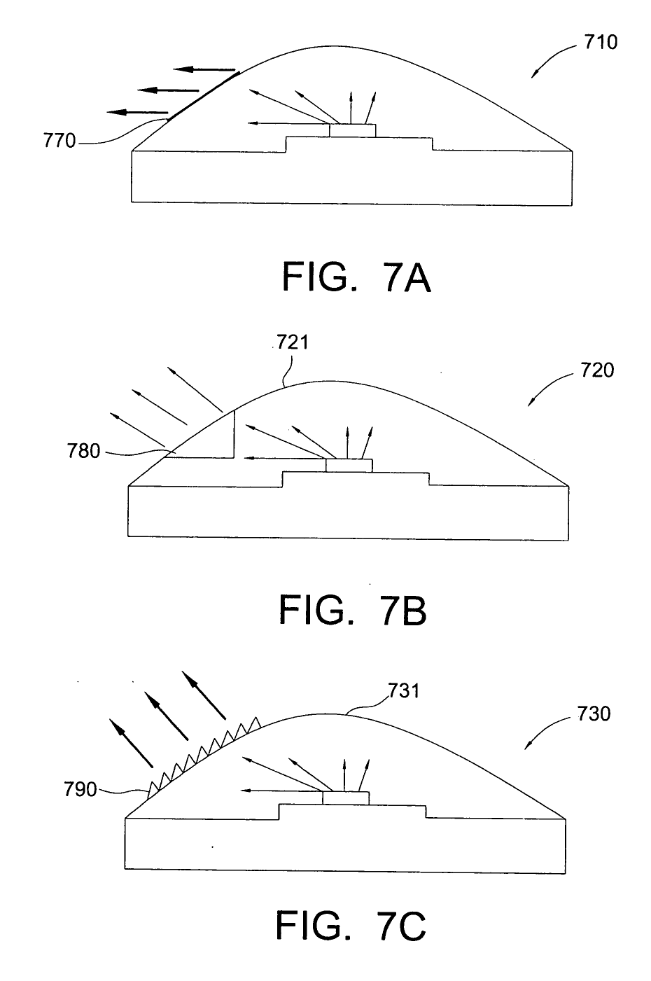

The separate optics 670 can be a color filter, a prim, a grism, or diffractive optics. The LED 710 with color filter type optics 770 is shown on FIG. 7A. The filter 770 can be specific-color ink. Color is selected by different inks, so that different color can be sensed and compared for feedback control. The LED 720 with prism type or grism type optics 780 is shown in FIG. 7B. By inserting a different material over the LED cup 721, a prism 780 can be formed. Partial light passes through the prism 780 so that the light output of different colors is separated and detected. As a result, the detected light output for each color can be used for feedback control. FIG. 7C illustrates an LED 730 with diffractive-optics 790, which has a grating 790 printed on the LED cup 731. Partial light is separated into a band of spectrum. Detector array or three photodiodes can be used to monitor the colors so that the detected bands can be used for feedback control.

In each of the embodiments, color filters may be associated with the photodiodes to render them selective to a particular spectral region of the RGB output, thus avoiding the need to pulse the LEDs and photodiodes as described in U.S. Pat. No. 6,127,783.

For cost-effective implementation, the compound parabolic contractor can approximately be a compound reflector in which elliptical reflector is used as an angle transformer, i.e., the two foci are the locations of energy distributions. Meanwhile, parabolic reflector is used as the parallel beam transformer. The contractor can be solid (not a cavity) to form an effective novel light pipe. The outer shape can be coated with highly reflective materials, typically Al. The shape of contractor can also approximately be a spline curve for fabrication.

The LED luminaire, which consisted of the contractor and/or the combiner, incorporates an array of red, green and blue emitting LEDs and a feedback arrangement to maintain a desired color balance for white-light illumination and colorful emissions with compact size and low loss of optical throughput. The feedback arrangement includes photodiodes positioned and enabled to separately measure the light output of the three-in-one contractor and a variety of feedback output that picks up a small fractional part of optical throughput. In one embodiment, a prism is positioned to pick up a fraction of light output and the fractional light is guided to single photodiode or array of photodiodes by which individual colors are measured for feedback control such that color balance could be maintained. In an alternate embodiment, a light guide is replaced for the prism. The light guide can be further replaced by diffractive optics (e.g., grating) as well as grism. To increase the output power performance and convenience of monitor, multiple-to-multiple contractor is incorporated in the LED luminaire.

It is noted that the present invention utilizes Winston cone as a basic light collection to achieve the highest efficiency of light collection. In this invention, Winston cone becomes a “multiple-entrance-port”-to-“multiple-exit-port” contractor effectively, an illuminator. Feedback sensors which monitor either light emission intensity or color variation can be positioned at the exit ports, while main light output emission can still be used as an illumination source. The shape of contractor can be downsized to make the LED luminaire compact by using an angle transformer. This invention is suggested to be of the highest-efficient LED RGB illuminator. With optical feedback control, this LED RGB illuminator is expected to have good performance in color balance, output emission control and lifetime stability. Multiple entrance ports allow more LED packages to be combined to exit port(s) such that output power can be dramatically increased.

For a “multiple-entrance-port”-to-“one-exit-port” contractor, a wavelength selective optical element is positioned at exit port to redirect a fractional light for feedback control. This is different from that of prior art, which proposed to use partial reflecting beam. For the configuration of the “multiple-entrance-port to multiple-exit-port contractor”, there is no need of a wavelength selective optical element, an assigned exit port can guide a fractional light output emission to sensor for feedback control.

Although specific embodiments have been illustrated and described, it will be obvious to those skilled in the art that various modifications may be made without departing from what is intended to be limited solely by the appended claims.

What is claimed is:

1. An LED luminaire, comprising:
an array of LEDs comprising at least one LED in each of a plurality of colors to generate a combined light output;
a multiple-to-one contractor positioned to direct the combined light output of the array of LEDs to a target light guide;
a pickup optical element positioned to extract a portion of the light output from the multiple-to-one contractor; and
a light sensor positioned to measure at least a portion of the extracted light so as to adjust the light output of the LEDs.

2. The LED luminaire of claim 1, wherein the pickup optical element is selected from a group consisting of a light guide, a color filter, a prism, a grating, a grism, and a combination thereof.

3. The LED luminaire of claim 1, further comprising:
means for supplying electrical current to the array of LEDs, so that the LEDs in each color have a light output, and the array of LEDs has the combined light output;
means for providing the extracted light output of each color separately to the light sensor;
means for comparing the measured light output for each color to a respective desired light output for each color; and
means for adjusting the electrical -current to the LEDs in each color based on the comparison to achieve a desired combined light output.

4. The LED luminaire of claim 3, wherein the means for providing the extracted light output of each color separately to the light sensor comprises means for selectively turning off the LEDs so that the light sensor measures the light output for each color separately in a series of time pulses.

5. The LED luminaire of claim 3, wherein the means for providing the extracted light output of each color separately to the light sensor comprises color filter means for selectively filtering out the light output of each separate LED color.

6. The LED luminaire of claim 5, wherein the light sensor comprises an array of photodiodes.

7. The LED luminaire of claim 6, wherein the color filter means comprises separate color filters associated with the individual photodiodes.

8. The LED luminaire of claim 6, wherein the light sensor further comprises a light diffuser and a light integrator.

9. An LED luminaire, comprising:
an array of LEDs comprising at least one LED in each of a plurality of colors;
a compound parabolic contractor positioned to direct the combined light output of the array of LEDs to a target light guide; and
an array of light sensors, each light sensor associated with an LED or a partial array of LEDs, each light sensor positioned to intercept and measure at least a portion of the light output of its associated LED or partial array of LEDs, at least first and second ones of the light sensors being adapted to intercept and measure light output from mutually-exclusive subsets of the LEDs.

10. The LED luminaire of claim 9, further comprising:
means for supplying electrical current to the LED array, whereby the LEDs in each color have a light output, and the LED array has a combined light output;
means for comparing the measured light output for each color to a respective desired light color output for each color; and
means for adjusting the electrical current to the LEDs in each color based on the comparison to achieve a desired combined light output.

11. The LED luminaire of claim 9, further comprising a filter configured and arranged with the first light sensor to pass light from a first one of the mutually-exclusive subsets of the LEDs to the first light sensor and to filter light from a second one of the mutually-exclusive subsets of the LEDs.

12. The LED luminaire of claim 11, further comprising a second filter configured and arranged with the second light sensor to pass light from the second one of the mutually-exclusive subsets of the LEDs to the second sensor and to filter light from the first one of the mutually-exclusive subsets of the LEDs.

13. The LED luminaire of claim 9, wherein the first light sensor is configured and arranged with the array of LEDs so that light from a first one of the mutually-exclusive subsets of LEDs reaches the first light sensor, and that light from a second one of the mutually-exclusive subsets of LEDs does not reach the first light sensor.

14. The LED luminaire of claim 13, wherein the second light sensor is configured and arranged with the array of LEDs so that light from the second one of the mutually-exclusive subsets of LEDs reaches the second light sensor, and that light from the first one of the mutually-exclusive subsets of LEDs does not reach the second light sensor.

15. An LED luminaire, comprising:
an array of LEDs comprising at least one LED in each of a plurality of colors;
separate optics positioned to correspond the array of LEDs so as to filter at least a portion of the light output of the LEDs in each color;
a combiner for guiding at least a portion of the filtered light output; and
an array of light sensors, each light sensor positioned to intercept and measure at least a portion of the light output guided by the combiner.

16. An LED luminaire, comprising:
an array of LEDs comprising at least one LED in each of plurality of colors;
a multiple-to-multiple contractor positioned to direct the combined light output of the array of LEDs to a target light guide; and
at least one light sensor positioned at one or several exit ports of the contractor to extract a portion of the light output back to the LED array to form the feedback control loop.

17. The LED luminaire of claim 16, further comprising:
means for supplying electrical current to the LED array, whereby the LEDs in each color have a light output, and the LED array has a combined light output;
means for providing the extracted light output of each color separately to the light sensor;
means for comparing the measured light output for each color to a respective desired light output for each color; and
means for adjusting the electrical current to the LEDs in each color based on the comparison to achieve a desired combined light output.

18. The LED luminaire of claim 17, wherein the means for providing the extracted light output of each color separately to the light sensor comprises means for selectively turning off the LEDs so that the light sensor measures the light output for each color separately in a series of time pulses.

19. The LED luminaire of claim 17, wherein the means for providing the extracted light output of each color separately to the light sensor comprises color filter means for selectively filtering out the light output of each separate LED color.

20. The LED luminaire of claim 19, wherein the light sensor comprises an array of photodiodes.

21. The LED luminaire of claim 20, wherein color filter means comprises separate color filters associated with the individual photodiodes.

22. The LED luminaire of claim 20, wherein the light sensor additionally comprises a light diffuser and a light integrator.
